(19) United States
(12) Patent Application Publication
(10) Pub. No.: US 2007/0144301 A1
(43) Pub. Date: Jun. 28, 2007

(54) Adjustment device for a bowden cable arrangement

(75) Inventors: Robert Kopetzky, Graz (DE); Veit Stossel, Nurnberg (DE); Frank Falster, Nurnberg (DE)

Correspondence Address: HUSCH & EPPENBERGER, LLC, 190 CARONDELET PLAZA, SUITE 600, ST. LOUIS, MO, 63105-3441, US

(73) Assignee: Schukra Geratebau AG, Berndorf (AT)

(21) Appl. No.: 10/568,161

(22) PCT Filed: Aug. 17, 2004
(86) PCT No.: PCT/EP04/09224

§ 371 Date: Jul. 26, 2006

(30) Foreign Application Priority Data
Aug. 22, 2003 (DE) 10338737.4

(51) Int. Cl. F16C 1/10

(52) U.S. Cl. 74/502.2

(57) ABSTRACT

An adjustment device for a Bowden cable arrangement is described in the form of a manual lock or tensioning lock, which comprises a housing (10), a threaded spindle (70) guided in the housing (10) in a torsionally-resistant and axially movable manner, which is to be connected by a wire to the Bowden cable arrangement, and two half-shell elements (50), which are arranged in the housing (10) in an axially-secure and rotatable manner, and are in threaded engagement with the threaded spindle (70). Located at the housing (10) is a shoulder element (16) with an opening (13) through which the wire of the Bowden cable arrangement is guided in the axial direction out of the adjustment device. Allocated to the shoulder element (16) is a sleeve (30), which is to be placed in positive fit on the shoulder element (16) and prevents any deformation of the shoulder element (16) when the adjustment device is actuated.

The present invention relates to an adjustment device for a Bowden cable arrangement, which can be used in particular for adjusting the camber of a pelvic and/or lumbar support arranged on the back of a seat, such as a motor vehicle seat. An adjustment device of this kind is also designated as an actuator or tensioning lock or manual lock, whereby a rotational movement is converted into a pulling or thrusting movement of a cable, line, or wire of the Bowden cable arrangement, and this can be effected, for example, with the aid of a handwheel or lever located at the individual seat in question.

An adjustment device of this kind is known, for example, from EP 0 706 338 B1 from Applicants. The adjustment device proposed in this specification comprises a first threaded section, guided so as to be movable axially in a housing but arranged so as to be torsionally resistant, in the form of a threaded spindle with an outer thread, which is arranged in threaded engagement with an inner thread of a second threaded part in the form of a threaded ring, which is arranged in the housing in an axially secure and rotatable manner. Arranged in the housing and in the threaded spindle is in each case an axial, mutually-flush central hole for the passage of a wire of a Bowden cable arrangement, whereby the central hole of the central spindle opens into an interior chamber pointing towards an adjustment handle, for accommodating the nipple of a corresponding thread end. In addition to this, a radial opening is formed in the side wall of the housing, and a transverse hole in the side wall of the threaded spindle, whereby the radial opening of the housing and the transverse hole of the threaded spindle are flush with one another at a corresponding setting position of the threaded spindle relative to the housing, and form a common passage which renders possible the passage of the nipple of the end of the wire. The opening in the side wall of the housing and the transverse hole in the side wall of the threaded spindle are connected with the central hole in each case by means of a slot, so that the nipple of the end of the wire can be inserted through the radial opening in the side wall of the housing and the correspondingly aligned transverse hole in the side wall of the threaded spindle, into the inner chamber of the threaded spindle in the radial direction. The wire can then be moved or pivoted along the slot formed in the housing and in the threaded spindle, into the central holes, with the result that the wire, of which the wire end is held with the nipple in the interior of the threaded spindle, is then guided in an axial direction from the threaded spindle and the housing. The wire of the Bowden cable arrangement is mounted in a movable manner in a sheath or in a cable, whereby this sheath is supported on a shoulder element which is formed in the axial direction to the housing. If the threaded ring is rotated, the threaded spindle is moved a greater or lesser distance into the threaded ring and into the housing, so that the wire is correspondingly drawn to a greater or lesser distance out of the sheath of the Bowden cable arrangement.

By way of the embodiment of the adjustment device described heretofore, in accordance with EP 0 706 338 B1, the introduction of the wire end with the nipple, and its anchoring in the axially movable threaded spindle, can be carried out without major installation effort or expenditure with the completely prefabricated Bowden cable arrangement. The installation of the Bowden cable arrangement at the adjustment device therefore saves both time and costs.

In EP 0 774 590 B1, a similar adjustment device for a Bowden cable arrangement is described, whereby it is proposed in this specification that the radial opening for accommodating the wire end with the nipple of the Bowden cable arrangement is to be formed in a section of the outer thread of the threaded spindle in such a way that this section too, with a Bowden cable suspended or hooked in it, can be screwed together with the inner thread of the other threaded section, which, according to this specification, is formed by two half-shell elements, assembled together and pressed into the housing.

With the conventional adjustment devices described heretofore, if the threaded spindle is adjusted a relatively high mechanical stress is created, and high demands are imposed with regard to the adjustment force to be applied. Despite clear improvements, the installation concept and the logistics material flow for the manufacture of the adjustment device and the corresponding individual components are still relatively elaborate and expensive.

Both in accordance with EP 0 706 338 B1, and in accordance with EP 0 774 590 B1, the sheath of the Bowden cable is supported on a shoulder element projecting in the axial direction from the housing.

According to EP 0 774 590 B1, this relates in particular to a shoulder element in the centre of which is formed the axial hole for the passage of the wire of the Bowden cable, whereby the shoulder element is formed by a circular or ring-shaped projection on the front face of the adjustment device, which is interrupted by the slot which connects the axial hole with the radial opening formed in the side wall of the housing. Because of this slot, the resistance strength against deformation of the ring-shaped shoulder is perceptibly weakened, with the result that, when the adjustment device or the Bowden cable respectively is actuated, with time a deformation of this ring-shaped shoulder may occur, which can even lead to the shoulder element breaking or to damage to the housing as a whole. Because as a rule the sheath of the Bowden cable is inserted into the ring-shaped projection, it is possible that, over the course of time, a “trench” will be formed in the sheath of the Bowden cable, which implies the corresponding deformation of the sheath.

In addition to this, according to EP 0 774 590 B1, stop elements are formed both in the threaded section of the half-shells as well as in the threaded section of the threaded spindle which is in threaded engagement with it, which restrict the movement of the threaded spindle in both axial directions in relation to the half-shells. Due to the formation of these stop elements in the threaded sections, however, if excessive adjustment force is used this may cause damage to the threaded sections. In addition, the stop elements are designed to be relatively delicate in form, with the result that, under certain circumstances, they are unable to resist a relatively high adjustment force. In addition to this, if a correspondingly high adjustment force is used, it is possible that the corresponding stop elements of the threaded spindles and the semi-shell elements will engage with each other, or hook together.

A further problem with conventional adjustment devices is the manufacture of the threaded spindle. To manufacture the threaded spindle, a correspondingly-shaped tool must be used to assess the spindle, whereby in that area of the spindle where the tool for the forming of the threaded spindle terminates, the thread of the threaded spindle last manufactured is flattened out. This leads, however, to an impairment of the function of the threaded spindle, with the result that, basically, the requirement pertains for a threaded spindle which on the one hand is easy to manufacture, and, on the other, is still availed of adequate stability and functional performance.

The conventional adjustment devices also have a relatively rigid housing design, whereby the material selection for the individual components is focused primarily on the interface between the housing and the Bowden cable inlet, since as a rule it is here that the greatest loading occurs. The material selection which results from this may, however, be unsuitable for the remaining interfaces in the adjustment device, for example between the threaded spindle and the half-shell elements.

In addition to this, according to EP 0 774 590 B1, the threaded spindle is guided in the housing in such a way that at its front end two noses, projecting diametrically in the radial direction, engage in corresponding cut-outs or grooves in the housing wall, running in the axial direction. These grooves or cut-outs are delimited by web-type or wall-type projections running in the circumferential direction of the housing, which project from the inner wall of the housing, and lead to an accumulation of material in the area of the guide of the threaded spindle in the housing, which can be problematic in terms of plastics engineering and leads to a loss of degree of efficiency when adjusting the threaded spindle. As described, the adjustment device can be actuated manually with the aid of a handwheel or lever, whereby, because of this accumulation of material in the area of the guide of the threaded spindle in the housing, guiding the spindle can sometimes be more difficult and sometimes easier, which is appraised by the user in the form of an irregular degree of adjustment force to be applied.

As described, with the known adjustment devices the nipple located on the end of the wire which is guided in is located in the interior of the threaded spindle. Once the nipple is in place, the wire of the Bowden cable arrangement runs in an axial direction from the interior of the threaded spindle, via the axial holes in the threaded spindle and the housing, to the outside. During the actuation of the adjustment device or the Bowden cable arrangement respectively, however, there may be a change in the location of the nipple inside the interior of the spindle, whereby, in particular, the nipple can also be in contact with the inner wall of the spindle, delimiting the spindle interior, which can lead to an impairment of the degree of efficiency due to friction. In addition to this, due to the fact that in this case the adjustment force is not applied to the Bowden cable arrangement precisely in the axial direction, this may result in the tilting of the threaded spindle inside the housing of the adjustment device, which in turn impairs the degree of efficiency and can even lead to damage to the threaded spindle and the housing.

A general design problem with adjustment devices of the type described heretofore is also the contrivance of the smoothest and most uniform possible run of the threaded spindle inside the adjustment device. In particular, the most uniform possible adjustment force should be required for the axial adjustment of the threaded spindle, whereby there should be no jerk-like resistance during the adjustment of the spindle. The formation of stop edges directly in the thread sections of the threaded spindle or of the half-shell elements according to EP 0 774 590 B1, in particular in conjunction with a lateral flattening of the thread of the spindle, can, however, lead to a relatively uneven run of the threaded spindle.

As has already been described, a particular problem arises with the manufacture of the threaded spindle. During the manufacture of the spindle, a slide element is pushed into the interior of the spindle, whereby in this case the most concentric position possible is required for the spindle in relation to the tool, to achieve the most filigree manufacture possible of the spindle. With conventional threaded spindles, however, the retention of the spindle during the insertion of the slide element is not guaranteed, nor during the formation of the outer thread.

From the description heretofore it can be seen that a large number of different demands are placed on adjustment devices for Bowden cable arrangements of the type described heretofore. What is common to these different demands, however, is that they prompt the attempt to achieve the smoothest possible run of the threaded spindle with simultaneous optimisation of the degree of efficiency and easy manufacture of the adjustment device.

The present invention is therefore based on the object of eliminating the problems described, and providing an adjustment device for a Bowden cable arrangement in which the functional performance of the adjustment device is improved, and with which, in particular, the simplest possible manufacture of the adjustment device can be achieved with, at the same time, an improved degree of efficiency and improved adjustment properties of the individual threaded parts of the adjustment device.

This object is achieved according to the invention by an adjustment device for a Bowden cable arrangement with the features of Claims 1, 14, 30, 37, 47, 54 and 62. The dependent claims define in each case preferred and advantageous embodiments of the present invention.

The adjustment device for a Bowden cable or line/cable drawing arrangement, which, depending on its design form can be designated as an actuator or tensioning lock or manual lock, comprises a housing, a first threaded part, which is guided in a torsionally-resistant and axially-movable manner in the housing and which is to be coupled to the Bowden cable, as well as a second threaded part, which is arranged in the housing in an axially-secure and rotatable manner, and which is in threaded engagement with the first threaded part. The first threaded part can in particular be designed in the form of a threaded spindle with an outer thread, while the second threaded part can in particular be in the form of a hollow cylinder or ring, with an inner thread. According to a preferred embodiment, the second threaded part comprises several part shell elements, in particular two half-shell elements, which when placed together produce the second threaded part and are to be pressed into the housing. It is of course also possible, however, for the function of the first and second threaded parts to be reversed, in such a way that the second threaded part is designed in the form of a threaded spindle and the first threaded part as a hollow cylinder or ring.

The first threaded part and the housing may in each case have radial openings in their side walls, with the result that, with the appropriate orientation of the first threaded part in relation to the housing, a wire of the Bowden cable arrangement or a nipple located on an end of the wire can be introduced through these openings in the radial direction into the first threaded part, in order to connect the Bowden cable arrangement or the wire respectively to the first threaded part. To this effect, in the first threaded part in particular a corresponding interior space is provided for, which is connected with the radial opening such that the wire end with the nipple comes to rest in this interior space of the first threaded part. Both in the first threaded part as well as in the housing it is also possible to make provision for an opening, running in the axial direction, at a longitudinal end or in the face sides, whereby the corresponding axial opening is connected with the radial opening in each case of the first threaded part or of the housing respectively, by means of a slot formed in the side wall of the threaded part or of the housing respectively, such that, after the wire end with the nipple has been placed in position, the wire of the Bowden cable arrangement can be moved along the slot in such a way that it finally runs in the axial direction, through the axial openings of the first threaded part and of the housing, to the outside. A sheath of the Bowden cable arrangement, in which the wire is mounted in a displaceable manner, is then supported preferably at the corresponding axial end of the housing.

According to a first aspect of the present invention, the housing has a projection with the axial opening to accommodate the Bowden cable arrangement. As a counterpiece to this projection, which projects in particular in the axial direction in a ring shape from the corresponding longitudinal end of the housing, and is interrupted by the slot described heretofore, a sleeve is provided which has an opening to accommodate the sheath of the Bowden cable arrangement. In addition to this, the sleeve also comprises a passage hole, through which the wire of the Bowden cable arrangement can be guided into the opening of the projection of the housing to form a coupling with the first housing part. The sleeve comprises a peripheral section which engages around the projection of the housing.

The sheath of the Bowden cable arrangement can itself be reinforced and surrounded by a sheath, for example made of brass, in order to facilitate the introduction of the sheath into the opening of the sheath referred to, and to provide adequate stability. As a result of the surrounding or encompassing of the shoulder by the sheath described heretofore, which is designed, in particular in the section turned towards the housing, as being complementary to the shape of the shoulder, the problem is avoided of the shoulder being deformed during an actuation of the adjustment device because of the slot formed in it, or due to other causes, which means that the original shape of the shoulder will be guaranteed by this sheath, leading to better stability of the shoulder, of the housing, and of the entire adjustment device. “Digging in” or stretching of the sheath of the Bowden cable arrangement will be avoided.

In addition to this, the sleeve and the stability which it guarantees make it possible for a suitable material to be selected for every component of the adjustment device, without the need to concentrate on the interface between the housing and the Bowden cable arrangement. For the housing, for example, a polyamide plastic with or without a fibreglass fraction can be used. For the first threaded part, which is designed preferably in the form of a threaded spindle, PBT (polybutylene terephthalate) can be used, which allows for a particularly high degree of precision to be achieved when adjusting the threaded spindle. For the second threaded part, which preferably comprises several part shell elements and which is in threaded engagement with the first threaded part, POM (polyoxymethylene) can be used, whereby this plastic is a particularly good sliding partner material for PBT. The sleeve which accommodates and supports the sheath of the Bowden cable arrangement can be made of a fibreglass-reinforced plastic, in particular a polyamide plastic with a fibreglass fraction (such as polyamide 6/6.6 with a fibreglass fraction), in order for adequate stability, strength, and good running properties to be achieved. It is therefore conceivable that the selection of the material can be optimised, depending on the function of the individual component.

As described, the sleeve described heretofore is preferably not used only to hold the shoulder and the housing together, but also, in particular, to support the sheath of the Bowden cable arrangement, so that the sheath of the Bowden cable arrangement is not located in the axial opening of the housing shoulder but in the corresponding axial opening of the sleeve, and is supported there. This opening is delimited in the interior of the sleeve by a corresponding contact surface, which has a passage hole for the wire of the Bowden cable arrangement, so that the wire can run through the sleeve into the axial opening of the shoulder of the housing of the adjustment device.

According to a second aspect of the present invention, stop elements are formed between the first and second threaded parts at threaded sections of the two threaded parts. The stop elements of the two threaded parts are in this situation designed in particular in such a way that the corresponding contact surfaces limit a movement of the two threaded parts towards one another in both the circumferential direction or the radial direction, as well as in the axial direction. In particular, the stop elements can be designed in such a way that positive fit contact surfaces are formed.

By means of this measure, a reliable delimitation of the relative movement of the two threaded parts towards each other, as well as the application of a relatively high adjustment force, can be avoided, whereby, in addition, damage to the two threaded parts or, respectively, of the adjustment device as a whole, can be avoided in the event of disproportionately high adjustment force being applied, resulting from misuse, for example. Hooking or the like between the two threaded parts is reliably avoided, whereby in particular, in the case of a stop element, the contact between the corresponding contact surfaces of the two threaded parts can be released again easily and with no problem.

Preferably, corresponding diametrically-opposed projections are formed on both threaded parts, in order to provide a reliable limitation on the relative movement between the two threaded parts. When forming the first threaded part as a threaded spindle, stop elements can be formed at a base or foot section of the threaded spindle in the form of a circumferential broadening with corresponding projections, whereby the height of the projections gradually increases in the circumferential direction of the threaded spindle. Both in the circumferential direction and in the axial direction, these projections define contact surfaces, whereby corresponding contact surfaces are formed and provided for which are complementary to these contact surfaces in the second threaded part also, which preferably are formed by several part shell elements. At the head section of the threaded spindle, nose-like projections can be provided, which likewise define contact surfaces in both the circumferential direction as well as in the axial direction, and which interact with complementary contact surfaces of the other threaded part. The nose-type projections can be provided with at least one rib, but preferably with several ribs located next to one another. This at least one rib, which in particular runs in a wave shape, serves as a bracing rib, which extends in particular in the longitudinal direction of the threaded spindle and can accommodate a linear load. The at least one rib can also have a protrusion, which serves at the same time as a stop opposite the inner wall of the housing. Overall, this arrangement of nose-like projections of the threaded spindles provides support for the capacity described heretofore to provide a positive-fit stop element outside the thread runs of the two threaded parts.

According to a third aspect of the present invention, one of the two threaded parts is in turn a threaded spindle with an outer thread, which is in threaded engagement with an inner thread of the other threaded part, whereby at least the outer thread of the threaded spindle is subdivided into several threaded sections, extending in each case in the longitudinal direction of the threaded spindle and spaced at intervals from one another in the circumferential direction of the threaded spindle by thread-free sections, or separated threaded sections. These thread-free sections, which can run in particular in a groove pattern in the longitudinal direction of the threaded spindle, make it possible for the tool used for the manufacture of the threaded spindle to close around the spindle in the area of these thread-free sections, without this having any effect on the thread course of the outer thread of the threaded spindle. By contrast with the prior art, therefore, no filigree separation surfaces need to be taken into consideration for the tool. However, since during the operation of the threaded spindle not all the points of the outer thread are used as contact points with the inner thread of the other threaded part, this subdivision of the outer thread of the threaded spindle also does not incur any impairment of the function or run of the threaded spindle.

Preferably, the outer thread of the threaded spindle is tripled, i.e. subdivided into three threaded sections divided equally in the circumferential direction of the threaded spindle, whereby the mid-lines of adjacent threaded sections in each case have an angle interval of 120° in the circumferential direction. As a result of this three-legged shoulder arrangement, particularly good stability and location of the threaded spindle in the inner thread of the other threaded part is guaranteed, since the position of the threaded spindle in the inner thread is statically determined.

According to a fourth aspect of the present invention, material accumulations in the area of the guide of the first threaded part in the housing are avoided. The ring-shaped projections provided in the adjustment device according to the prior art, which are interrupted by the guide grooves, are at least in part done away with according to this aspect of the invention, with the result that at least that peripheral material which is not required for a reliable guidance of the first thread part in the housing is omitted, in order to avoid unnecessary accumulations of material. The savings on material achieved by this not only reduce the costs of manufacture, but also achieve an improvement in the degree of efficiency in the area of the guidance of the first threaded part in the housing.

According to this aspect it is therefore proposed that material cut-outs be provided for between adjacent projections, which project inwards from the inner wall of the housing and delimit corresponding guide grooves for the first threaded part, in such a way that the adjacent projections are not connected with one another over their entire axial length. The material cut-outs can in this situation also be of such a nature, in particular, that the adjacent projections in the circumferential direction are separated from one another over the entire length by means of the corresponding material cut-out at that point at which they do not delimit a guide groove.

According to a fifth aspect of the present invention, an opening is provided in turn in the first threaded part, at one of its axial ends or longitudinal ends, for the wire of the Bowden cable arrangement, whereby positioning means are provided in this opening of the first threaded part, this part being in turn preferably designed as a threaded spindle with an outer thread, for the positioning of the wire or, respectively, of the nipple located at the corresponding wire end, in the opening of the first threaded part. These positioning means can in particular be designed in such a way that they retain the wire or the nipple in position essentially centrally in the opening, and therefore prevent the wire or the nipple located at the corresponding wire end from coming in contact with the inner wall or the edge of this opening of the first threaded part, such that any impairment of the degree of efficiency by the friction incurred in this situation, or the tilting of the first threaded part as a result of an adjustment force in the axial direction not entirely transferred onto the wire, will be avoided.

The positioning means may comprise several projections protruding from the inner wall of the opening or the first threaded part, in particular of rib type. These projections are preferably distributed uniformly in the circumferential direction of the opening, whereby in particular four such rib-shaped projections can be provided for.

According to a sixth aspect of the present invention, one of the two threaded parts is in turn a threaded spindle with an outer thread, which is in threaded engagement with an inner thread of the other threaded part. The other threaded part is designed in particular in the form of a hollow cylindrical or ring-shaped body, on the inner walls of which corresponding threaded sections of the inner thread are formed. These part shell elements are brought together at corresponding separation surfaces, and are then pressed into the housing, whereby for this purpose corresponding part sections of a projection, preferably circumferential, can be provided on the outer sides of the part shell elements, and which can engage in a correspondingly designed indentation in the inside wall of the housing, preferably likewise circumferential. On the separation surfaces of the part shell elements the threaded sections are rounded in the circumferential direction, so that, after the part shell elements have been assembled, a sharp transition line is avoided between the threaded part section of the one part shell element to the threaded part section of the other part shell element. When the adjustment device is in operation, the radii of the threaded part sections or part thread courses formed at the separation surfaces of the part shell elements guarantee a rounder course of the first threaded part or of the threaded spindle respectively in the complementary inner thread formed by the part shell elements, which, in particular with a manual adjustment, is more agreeable for the individual user and leads to an improvement in the degree of efficiency.

At the separation surfaces of the part shell elements, projection-indentation combinations can be provided for, of such a nature that, when the part shell elements are assembled, in each case a projection on the separation surface of the one part shell element can engage into a corresponding indentation on the separation surface of the other part shell element. Preferably, a projection-indentation combination of this nature is provided on each separation surface of each part shell element.

According to a seventh aspect of the present invention, one of the two threaded parts is designed as a threaded spindle, and has at least one opening, in particular a radial opening, in the side wall of the threaded spindle, which makes it possible for the corresponding spindle to be held in position during manufacture and in particular during the insertion of the slide element referred to heretofore, in order to allow for a more filigree manufacture of the threaded spindle. This at least one opening is provided in particular in a thread-free section of the threaded spindle, preferably at the head-side end of the threaded spindle. In addition to this, the opening can be designed to be diametrically opposite to a further opening in the side wall of the threaded spindle, whereby the further opening is in particular that radial opening which is provided for the introduction of the wire or respectively the nipple located on the corresponding wire end, of the Bowden cable arrangement.

The aspects of the present invention described heretofore are in principle independent of one another and in each case lead independently to an improvement in the manufacturability, a reduction in costs, an improvement in adjustment and running properties, and, in consequence, to an improvement in performance and/or the degree of efficiency of the adjustment device. Preferably, however, the different aspects referred to heretofore are combined in one and the same adjustment device.

The adjustment device according to the invention is well-suited preferably as an adjustment device for a Bowden cable arrangement for adjusting the camber of a pelvic and/or lumbar support arranged on the back of a seat, such as a motor vehicle seat. The adjustment device according to the invention, however, is not restricted to this preferred scope of application, and can, in addition, be actuated both manually as well as electrically.

The present invention is explained hereinafter in greater detail, by reference to the drawings on the basis of a preferred embodiment.

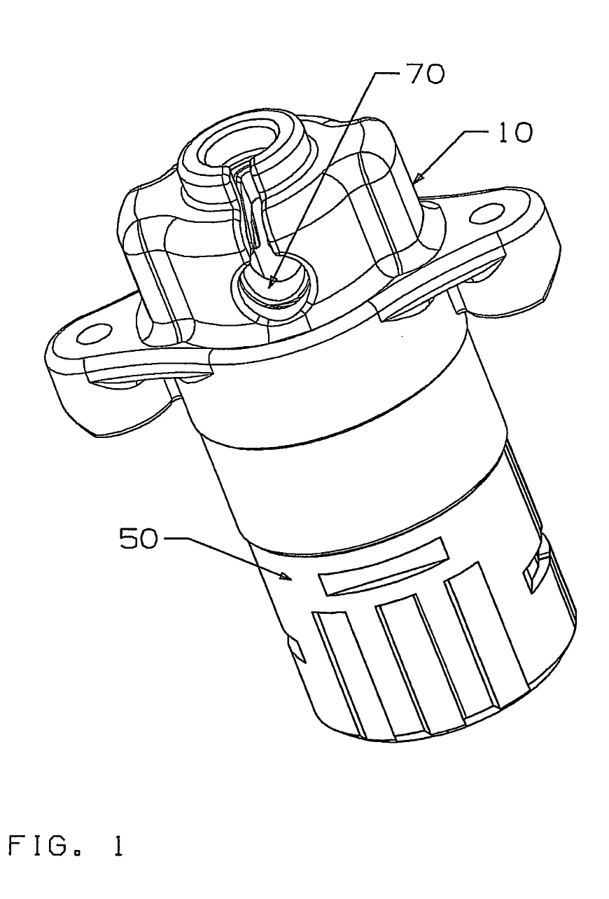

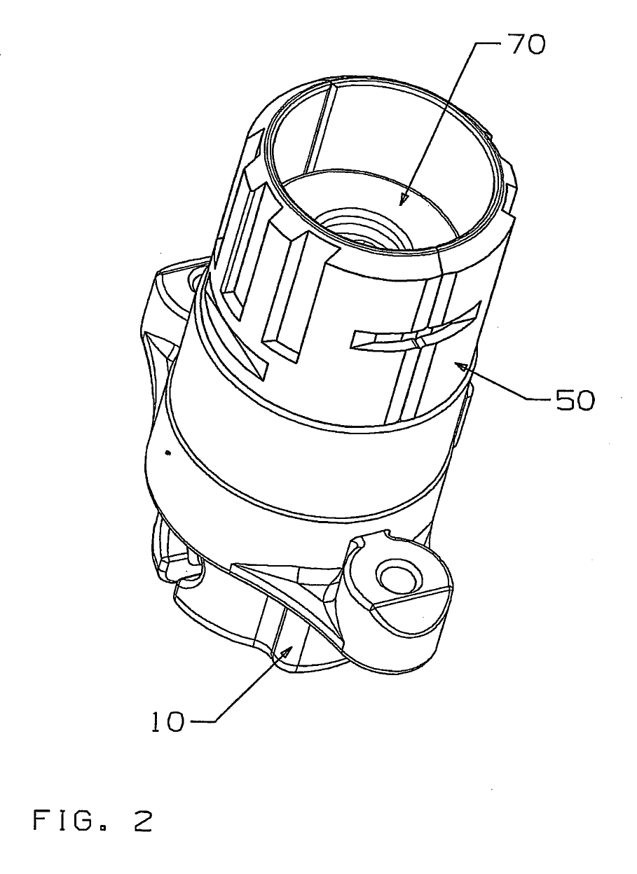

FIG. 1 and FIG. 2 show perspective views of an adjustment device for a Bowden cable arrangement according to a preferred embodiment of the invention in the assembled state;

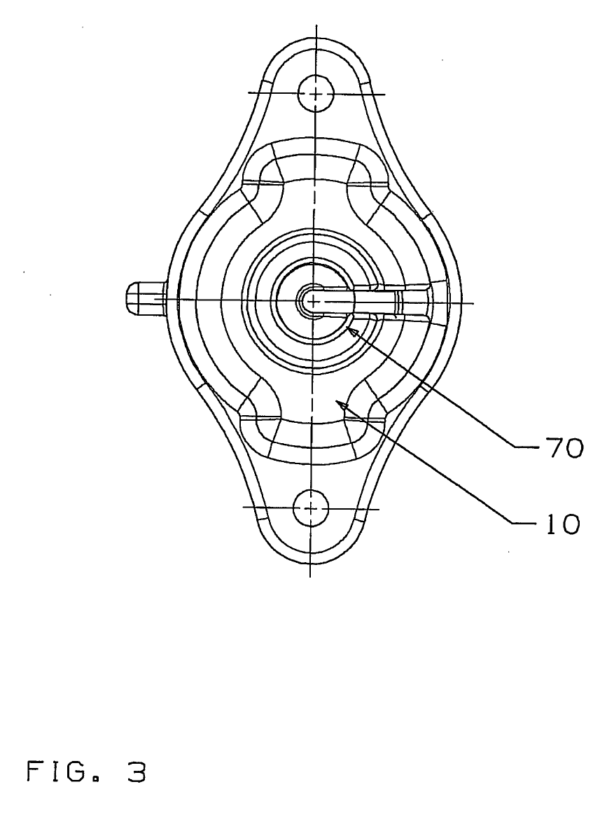

FIG. 3 shows a plan view of the adjustment device from above in the assembled state,

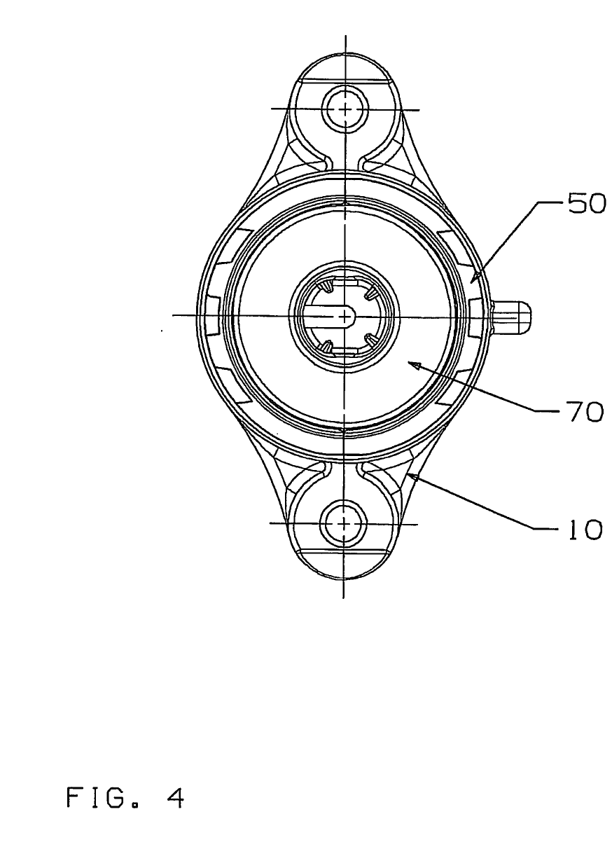

FIG. 4 shows a plan view of the adjustment device from below in the assembled state,

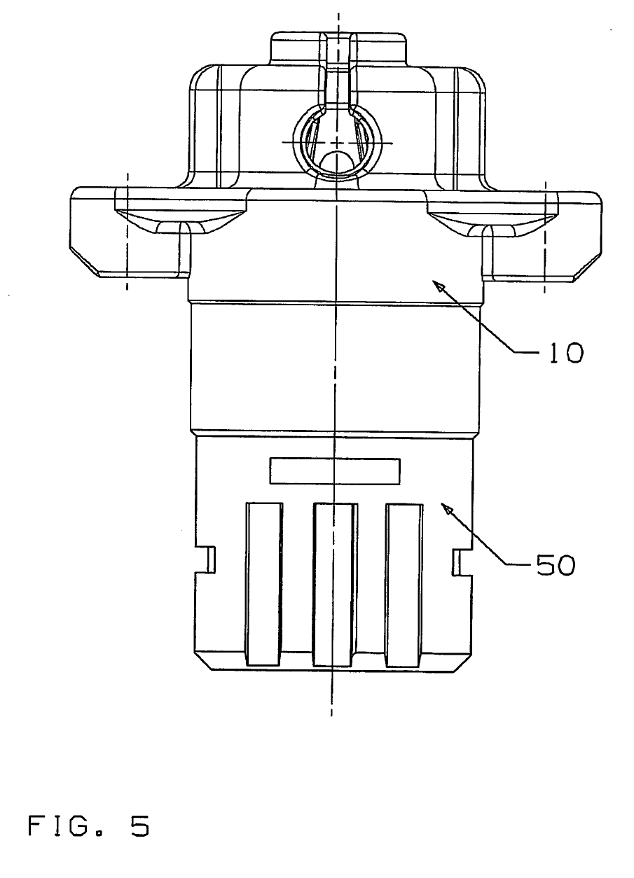

FIG. 5 shows a front view of the adjustment device in the assembled state,

FIG. 6 shows a side view of the adjustment device in the assembled state,

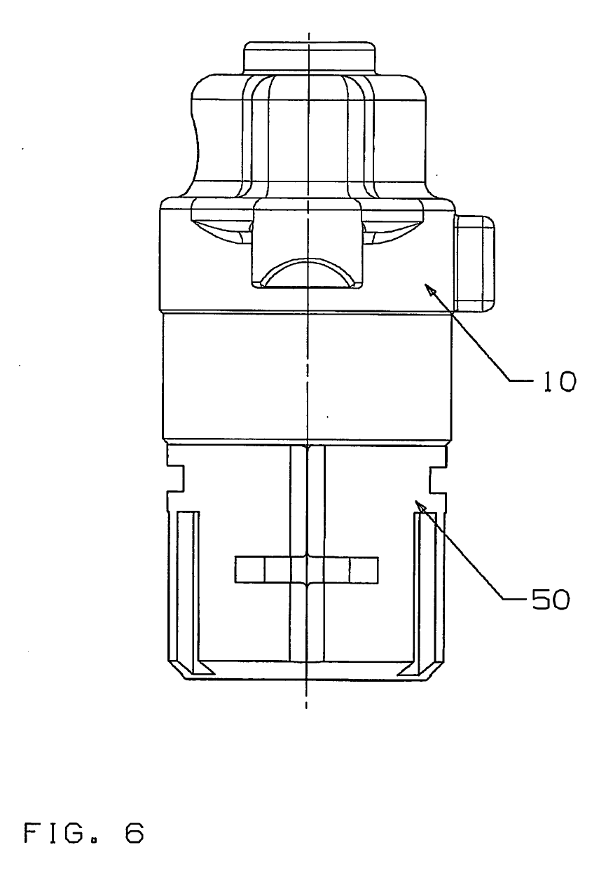

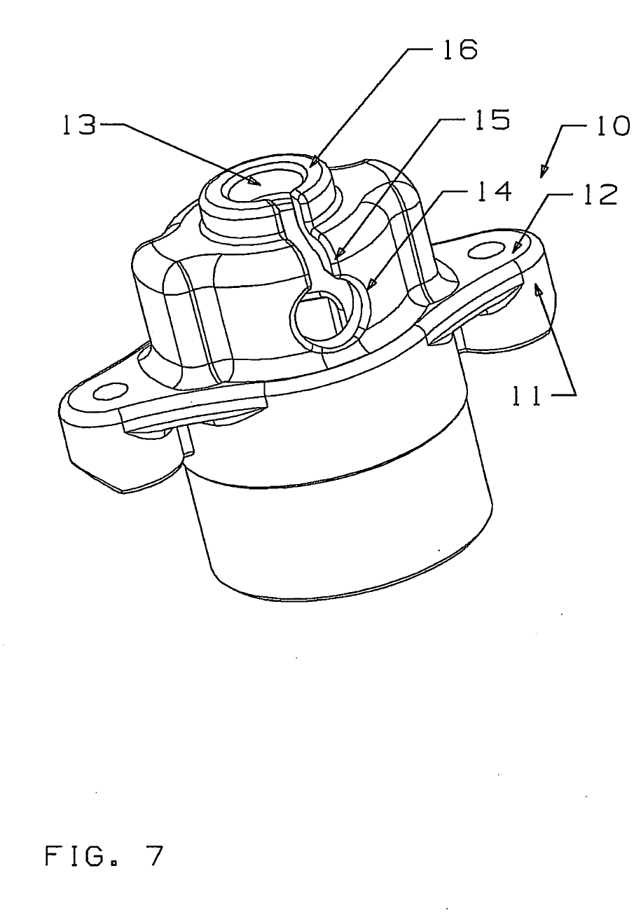

FIG. 7 shows a perspective view of a housing of the adjustment device from FIGS. 1-6,

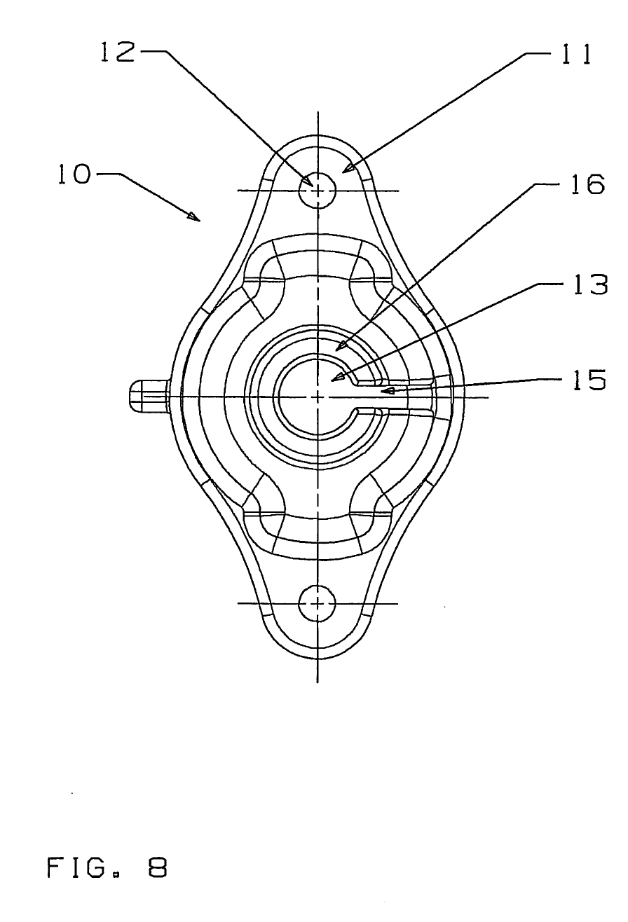

FIG. 8 shows a plan view of the housing from above,

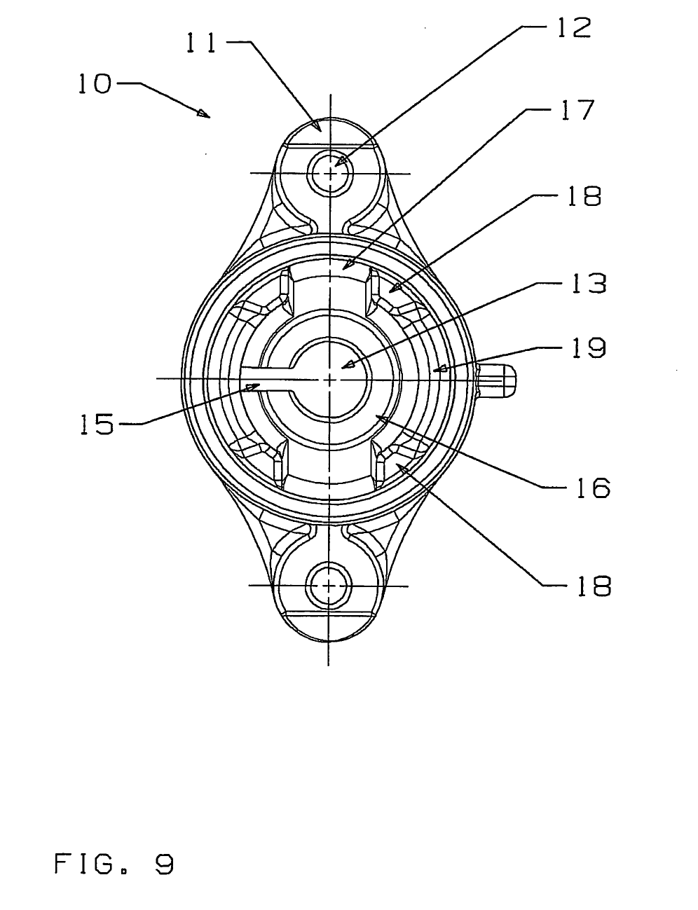

FIG. 9 shows a plan view of the housing from below,

FIG. 10 shows a front view of the housing,

FIG. 11 shows a side view of the housing,

FIG. 12 shows a plan view of a sleeve for the adjustment device from FIG. 1-FIG. 6 from below,

FIG. 13 shows a side view of the sleeve,

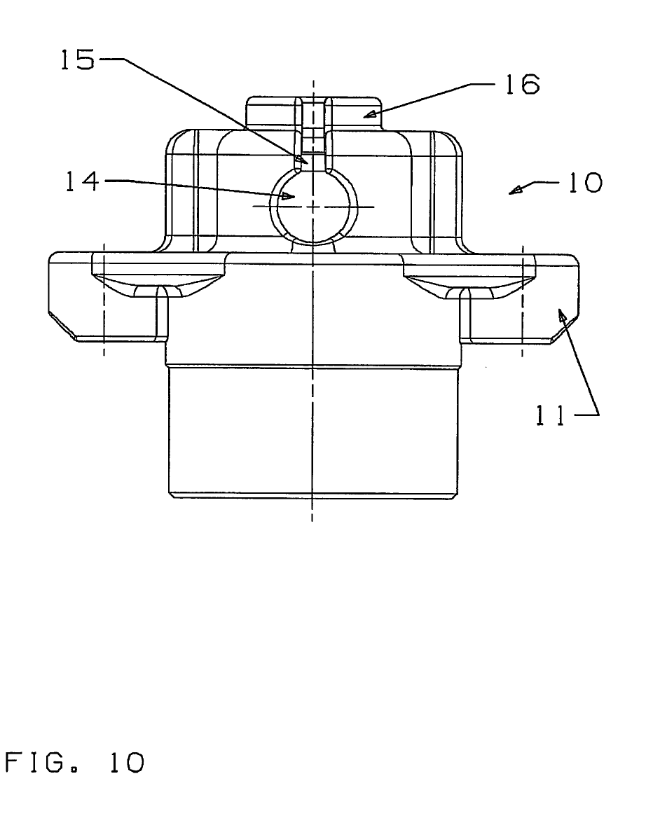

FIG. 14 shows a plan view of the sleeve from above,

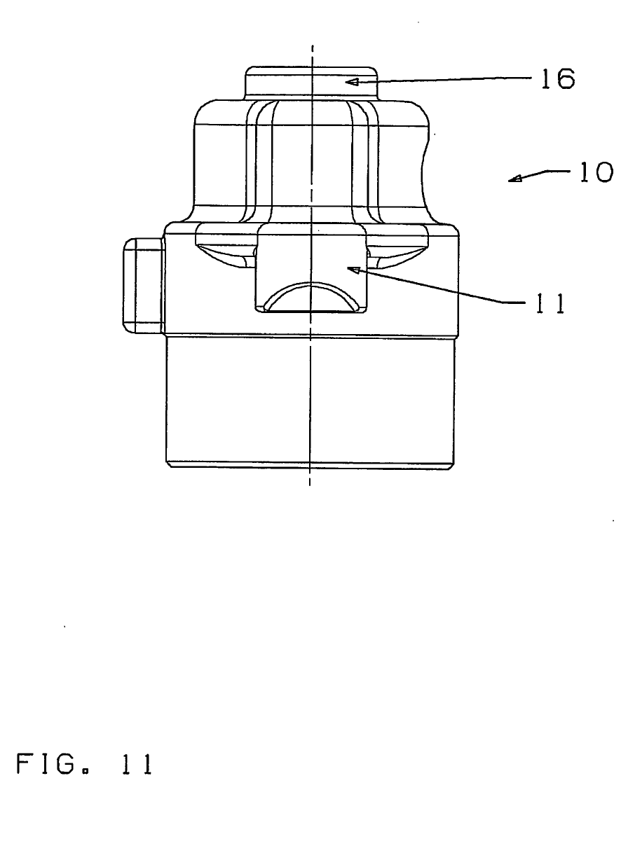

FIG. 15 shows a perspective view of the sleeve,

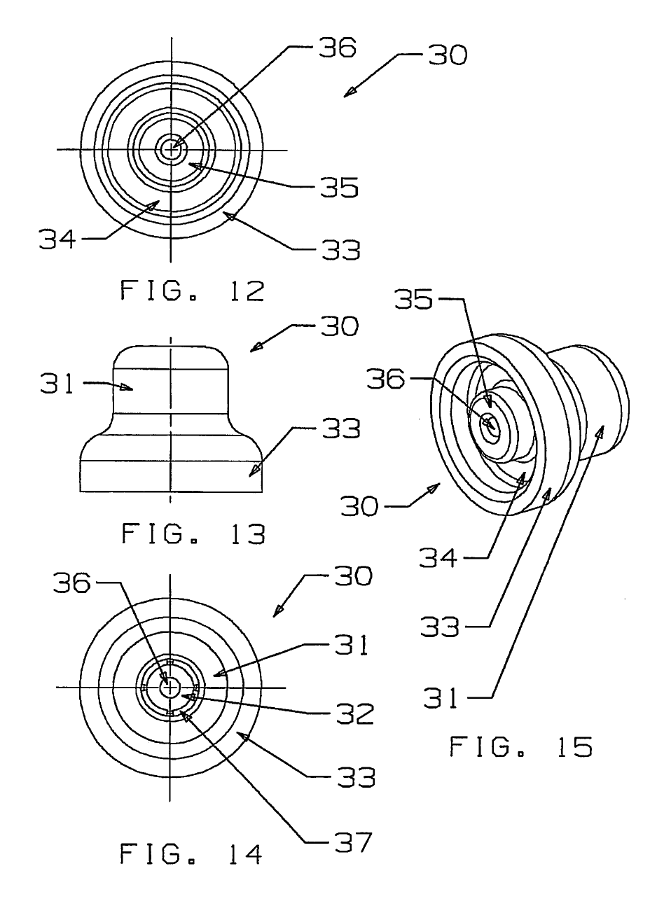

FIG. 16 shows a perspective view of a half-shell element of the adjustment device from FIG. 1-FIG. 6,

FIG. 17 shows a front view of the half-shell element,

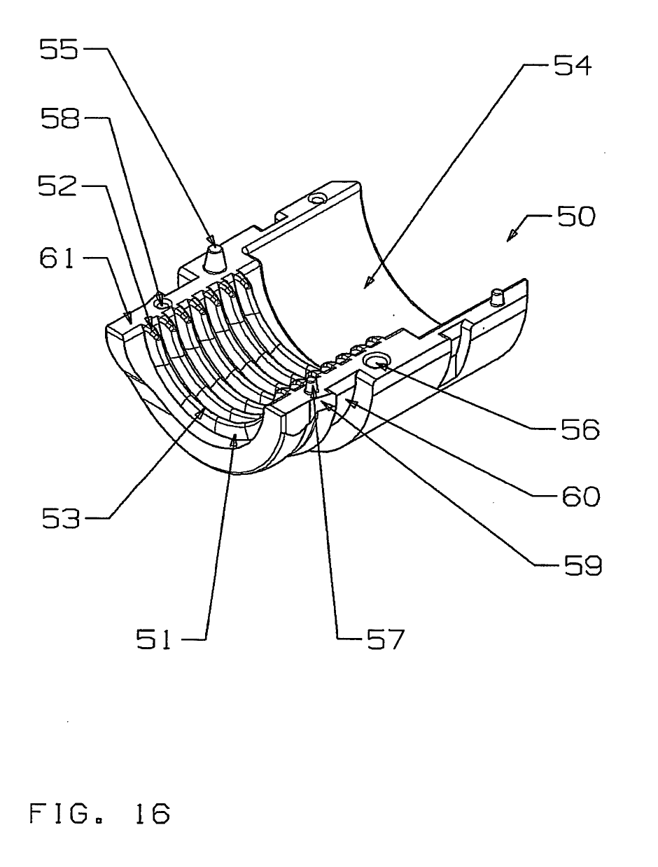

FIG. 18 shows a side view of the half-shell element,

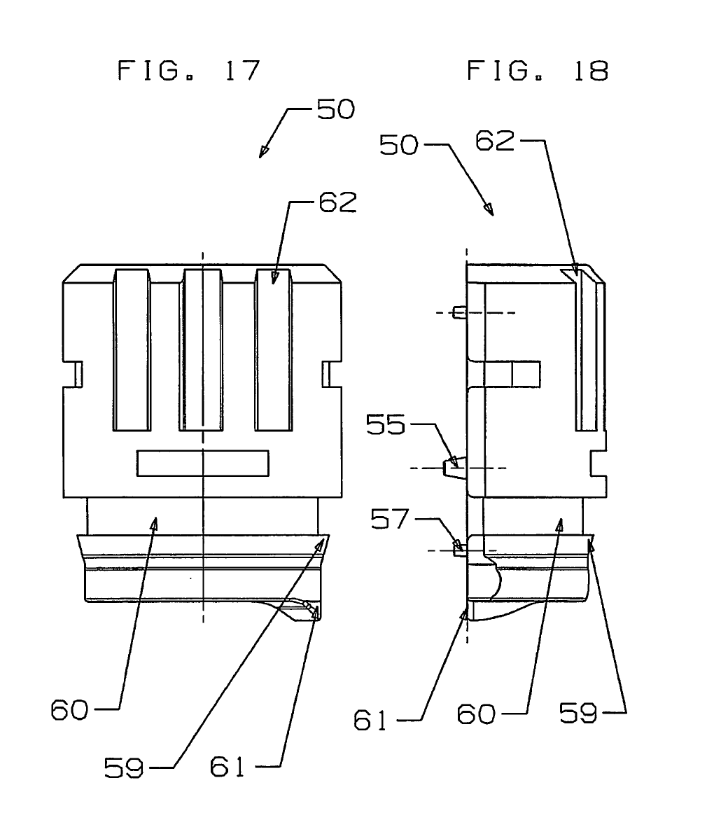

FIG. 19 shows a plan view of the half-shell element from above,

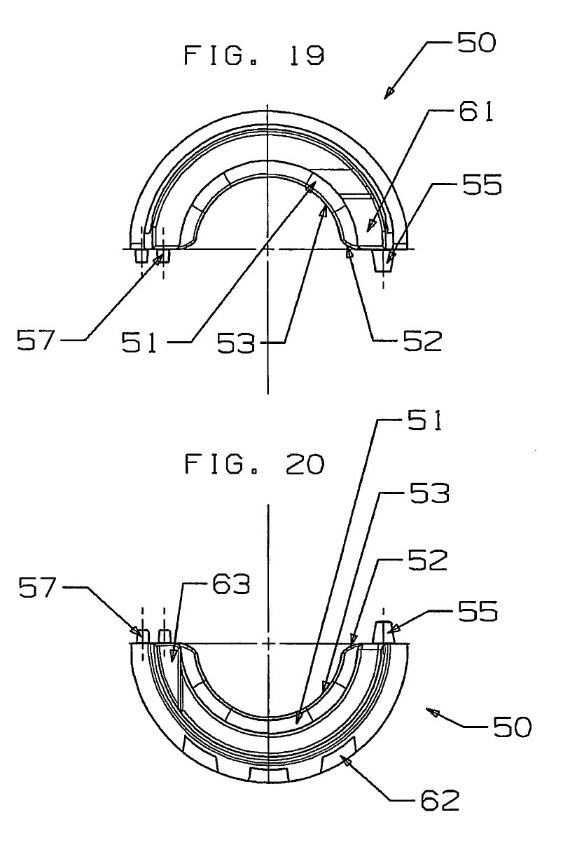

FIG. 20 shows a plan view of the half-shell element from below,

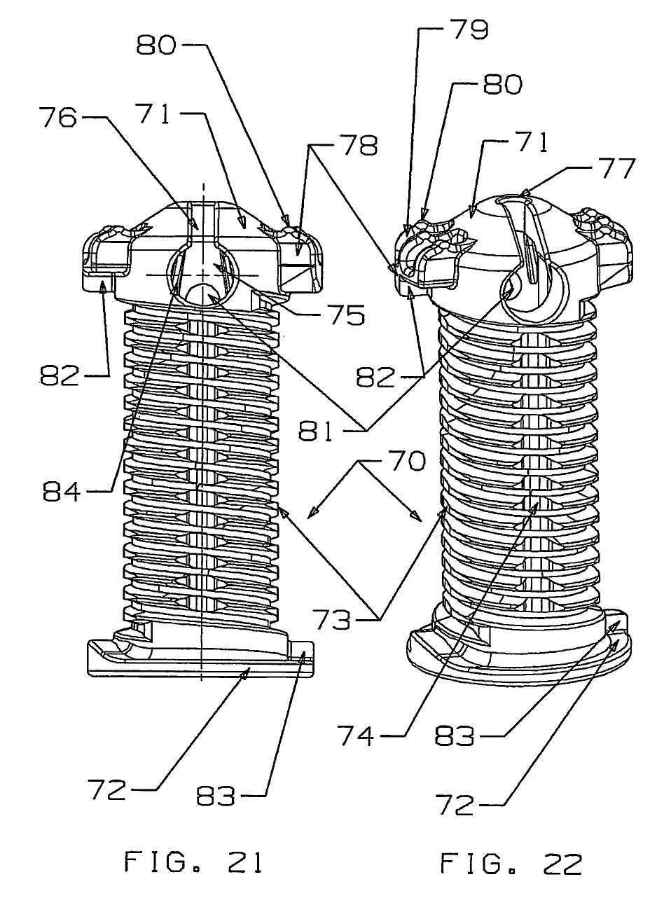

FIG. 21 shows a front view of a threaded spindle of the adjustment device from FIG. 1-FIG. 6,

FIG. 22 shows a perspective view of the threaded spindle,

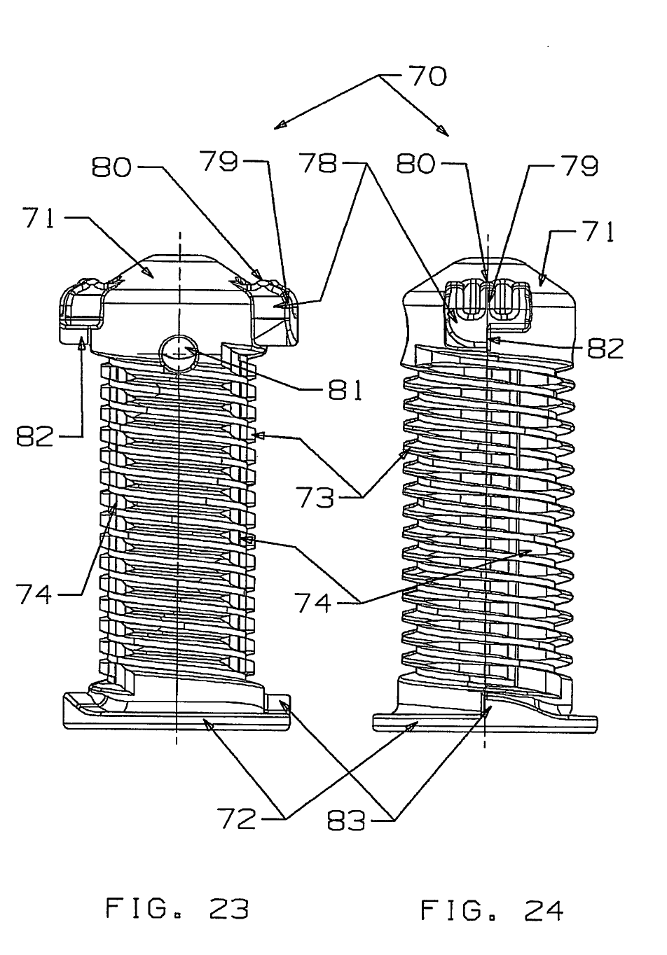

FIG. 23 shows a rear view of the threaded spindle,

FIG. 24 shows a side view of the threaded spindle,

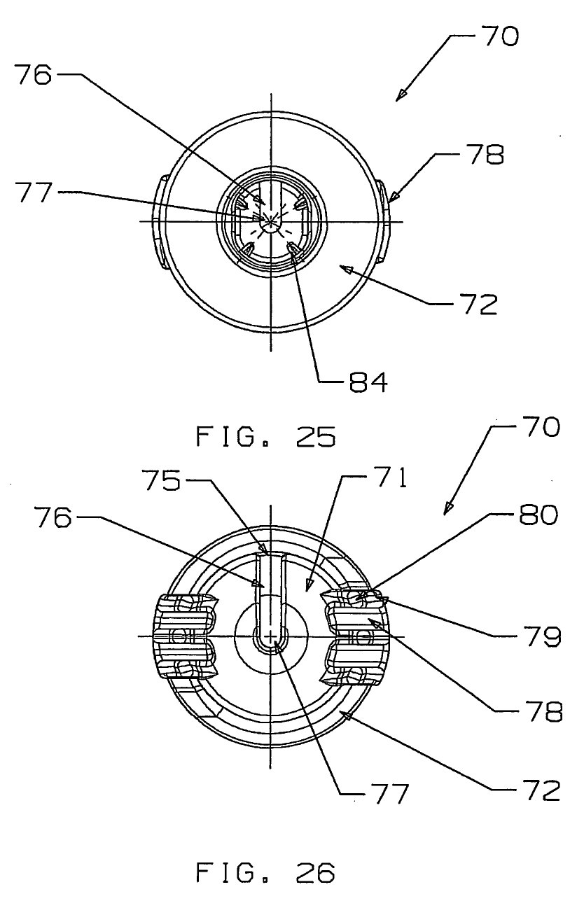

FIG. 25 shows a plan view of the threaded spindle from below, and

FIG. 26 shows a plan view of the threaded spindle from above.

The adjustment device represented in FIG. 1-FIG. 6 serves to adjust a Bowden cable arrangement (not shown), or more precisely to adjust a moveable wire located in a sheath of the Bowden cable arrangement. The essential constituent parts of the adjustment device, which can also be designated as a spindle actuator or tensioning lock or manual lock, are a housing 10, two half-shell elements 50, which in the assembled state form a hollow cylindrical body, and a threaded spindle 70. The two half-shell elements 50 are arranged in the housing 10 in an axially-secured and rotatable manner, while the threaded spindle 70 is guided in the housing in a torsionally-resistant and axially-movable manner. The threaded spindle 70 is to be coupled to the Bowden cable arrangement or, respectively, the wire of the Bowden cable arrangement, so that, depending on the axial movement of the threaded spindle 70 inside the housing 10 and inside the half-shell elements 50, the wire of the Bowden cable arrangement is drawn further or less far into the housing 10. This fact can be used, for example, to adjust the camber of a lumbar support coupled to the other end of the wire of the Bowden cable arrangement. There are already various solutions in this respect known from the prior, for adjusting the camber of a lumbar support by means of a Bowden cable arrangement, so that this need not be discussed here in any greater detail.

Assigned to the adjustment device represented in FIG. 1-FIG. 6 is, in addition, a sleeve, not represented in these Figures, which is shown in detail in FIG. 12-FIG. 15, and on which an essentially ring-shaped shoulder of the housing 10 is to be set. The individual constituent parts of the adjustment device from FIG. 1-FIG. 6 and the sleeve are explained hereinafter by reference to FIG. 7-FIG. 26.

FIG. 7 shows a perspective view of the housing 10, while FIG. 8 represents a plan view of the housing 10 from above, FIG. 9 a plan view of the housing 10 from below, FIG. 10 a front view of the housing 10, and FIG. 11 a side view of the housing 10.

The housing 10 is made of one piece of a polyamide plastic, if appropriate with a fibreglass fraction. The housing 10 has essentially the form of a hollow cylinder, whereby two flange-like projections 11 are formed from the side wall of the housing 10, with securing holes 12, which project outwards diametrically from the side wall of the housing 10. With the aid of these flange-like projections 11 and the securing holes 12 formed therein, the housing 10 (with the half-shell elements 50 located therein, the threaded spindle 70 located therein, and the sleeve 30 placed on the housing 10) can be secured to a desired object, for example a motor vehicle seat. In addition, in the side wall of the housing 10 is a radial opening 14, which is connected via a slot 15, likewise formed in the side wall, with an axial opening 13 of the housing 10. The axial opening 13 of the housing 10 is defined by a ring-shaped shoulder 16, which projects in the axial direction from the front face or the axial end surface respectively of the housing 10. The slot 15 also runs through this ring-shaped shoulder or projection 16.

The radial opening 14 serves to introduce a nipple, located on the corresponding wire end of the Bowden cable arrangement, through the radial opening 14, whereby the wire of the Bowden cable arrangement is then moved through the slot 15 into the axial opening 13, so that the wire runs from the inside of the housing 10 through the axial opening 13 in the longitudinal direction of the housing 10 to the outside.

The plan view of the housing 10 from below shown in FIG. 9 makes it clear that projections 18 are formed inside the housing 10, which project from the inner wall of the housing 10 in the radial direction. These projections 18 define guide grooves 17 running in the longitudinal direction, into which nose-shaped projections 78 of the threaded spindle 70 can be located, in order for the threaded spindle 70 to be able to move in the longitudinal direction along these guide grooves 17 inside the housing 10.

From FIG. 9 it can also be seen that the radial projections 18, in each case adjacent in the circumferential direction of the housing 10, are not connected to one another over their entire axial length in the circumferential direction. Instead of this, material cut-outs 19 are provided between each two adjacent radial projections 18 in the circumferential direction, whereby these material cut-outs 19 can only partially extend over the axial length of the radial projections 18 or also over the entire axial length of the radial projections 18, whereby, in the latter case, the radial projections 18, adjacent in the circumferential direction of the housing 10 are entirely separated from one another along their entire axial length. Due to these material cut-outs 19, which therefore prevent the radial projections 18 from extending in ring or wall fashion over a larger surface of the inner wall of the housing 10, it is guaranteed that excess material is omitted in the area of the guide of the threaded spindle 70 in order to avoid unnecessary material accumulations, which could be problematic with regard to plastics engineering. Independently of the cheaper manufacturing costs resulting from this, an improvement is also hereby achieved in the degree of efficiency, since unnecessary material accumulations in the area of the guide of the threaded spindle 70 can frequently cause resistances when introducing the threaded spindle 70 or the corresponding nose-shaped projections 78 into the guide grooves 17.

With the embodiment shown in FIG. 9, the radial projections 18, which define the axial guide grooves 17, are essentially trapezoidal shaped in the cross-section. In principle, however, the projections 18 can have any desired shape, and are also designed with a lower thickness, so long as a reliable guidance of the threaded spindle 70 in the guide grooves 17 is guaranteed. In addition, it is sufficient if the radial projections 18 in the area of the face-side end section of the housing 10 are arranged in its interior, since the threaded spindle 70, as explained in greater detail hereinafter, is adequately retained by the half-shell elements 50 at the opposed longitudinal end of the housing 10.

The sleeve represented in FIG. 12-FIG. 15, which is to be placed on the ring-shaped shoulder or projection 16 of the housing 10, will now be explained in greater detail. In this situation, FIG. 12 shows a plan view of the sleeve 30 from below, FIG. 13 shows a side view of the sleeve 30, FIG. 14 shows a plan view of the sleeve 30 from above, and FIG. 15 shows a perspective view of the sleeve 30.

The sleeve 30 comprises essentially an accommodation section 31 and a base or peripheral section 33, which are formed at both longitudinal ends of the sleeve 30. The sleeve 30 is designed to be essentially rotationally symmetric to its longitudinal mid-axis and bell-shaped.

The accommodation section 31 has an opening running in the longitudinal direction, into which the sheath of the Bowden cable arrangement is to be guided. The dimensions of the hole 32 correspond in this situation essentially to the dimensions of the sleeve of the Bowden cable arrangement, whereby, in addition, as can be seen from FIG. 14, ribs arranged uniformly in the circumferential direction from the inner wall can project in a radial direction, in order to fix the sheath of the Bowden cable arrangement in the opening 32.

As can be seen from FIG. 15, a ring-shaped projection 35 extends from the bottom end of the accommodation section 31 in the longitudinal direction, whereby in the middle area of this ring-shaped projection 35 a passage hole 36 is formed, through which a wire, mounted so as to be movable in the sheath, can be guided. The surface of the ring-shaped projection 35 turned towards the accommodation section 31 serves at the same time as a stop surface for the sheath of the Bowden cable arrangement, i.e. the sheath can be introduced into the opening 32 as far as the base of the ring-shaped indentation 35.

The peripheral area 33 of the sleeve 30, as can likewise be seen from FIG. 15, is essentially ring-shaped, and separated from the ring-shaped projection 35 by an indentation or groove 34, likewise essentially ring-shaped. The shape and dimensions of the indentation 34 are in this situation chosen to be essentially complementary to the shape and indentation of the ring-shaped projection 16 of the housing 10. By contrast with the ring-shaped projection 16 of the housing 10, however, the peripheral area 33, which is essentially circular in cross-section, is closed. The ring-shaped projection 35 and the ring-shaped indentation 34 are also essentially circular in cross-section.

In practice, the sheath of the Bowden cable arrangement is guided into the opening 32 of the accommodation section 31 of the sleeve 30, and the wire of the Bowden cable arrangement is guided through the passage hole 36. The corresponding wire end, with the nipple attached to it, is then guided as described through the radial opening 14 in the side wall of the housing 10 (as well as through a radial opening 75, formed accordingly in the threaded spindle 70, which will be explained in greater detail hereinafter), and is linked at that point to the threaded spindle 70. The wire is then moved through the slot 15 in the side wall of the housing 10 (and a corresponding slot 76 formed in the side wall of the threaded spindle 70) into the axial opening 13 of the housing 10 (and a correspondingly formed axial opening 77 of the threaded spindle 70), so that it runs in the longitudinal direction of the housing 10 and of the threaded spindle 70. The sleeve 30 is then pushed or placed on the axial projection 16 of the housing 10, whereby the peripheral section 33 and the ring-shaped indentation 34, defined by the ring-shaped projection 35 and the peripheral section 33, are formed in such a way that the axial projection 16 of the housing 10 fits as precisely as possible into this ring-shaped indentation 34 of the sleeve 30 and is held between the peripheral section 33 and the ring-shaped projection 35 of the sleeve 30 in positive fit. In particular, the peripheral section 33 encompasses the axial projection 16 of the housing entirely, so that even if substantial adjustment forces are exerted on the Bowden cable arrangement, and consequently also on the sheath of the Bowden cable arrangement, the slot 15 formed in the projection 16 will be held together and cannot expand. The axial projection 16 of the housing 10 is therefore protected against deformation. Likewise, “digging in” or stretching of the sheath of the Bowden cable arrangement can be reliably avoided, since the sheath of the Bowden cable arrangement, as described, is located in the opening 32 of the accommodation section 31 of the sleeve 30, and is held there, likewise in positive fit, through the inner wall of the opening 32 and the radial ribs 37 formed there, and the stop surface running essentially perpendicular to the longitudinal axis of the sleeve 30, at the base of the ring-shaped projection 35.

The sleeve 30, like the housing 10, can be made of a polyamide plastic, such as polyamide 6/6.6, whereby the sleeve should preferably be reinforced with fibreglass in order to improve the stability and strength of the sleeve 30.

The two half-shell elements 50 of the adjustment device shown in FIG. 1-FIG. 6 will be explained in greater detail hereinafter. In this context, FIG. 16 shows a perspective view of the half-shell elements 50, while FIG. 17 shows a front view of the half-shell element 50, FIG. 18 a side view of the half-shell element 50, FIG. 19 a plan view of the half-shell element 50 from above, and FIG. 20 a plan view of the half-shell element 50 from below.

As can be seen from FIG. 16, each of the two half-shell elements 50 is essentially semi-cylindrical in shape and has at one longitudinal end a section with an internal thread 51 and at its other longitudinal end a hollow cavity 54, in which a base element 72 of the threaded spindle 70, to be explained in greater detail hereinafter, is guided in an axial direction. The inner thread of each half-shell element 50, as can be seen from FIG. 16, is provided with roundings 53 in the radial direction as well as laterally in the area of the separation surfaces with roundings 52. If the two half-shell elements 50 are brought together at their separation surfaces, the roundings and radii 52, 53, allow for the round run of the threaded spindle 70 inside the half-shell elements 50, whereby in particular due to the lateral roundings 52 provided for in the area of the separation surfaces, a sharp transition is avoided between the inner thread sections of the two half-shell elements 50, so that the threaded spindle 70 can be screwed in and out of the half-shell elements 50 and the housing 10 without any substantial resistance.

Each separation surface of each half-shell element 50 has a combination of a projection and an indentation. In this context, it can be seen from FIG. 16 that the one separation surface of each half-shell element 50 has a relatively large projection 55, while the other separation surface has a relatively small projection 57. In addition to this, the first separation surface has an indentation 58 to accommodate the relatively small projection 57 of the other half-shell element, while the other separation surface of each half-shell element 50 adjacent to the relatively small projection 57 has an indentation 56 to accommodate the relatively large projection 55 of the other half-shell element 50. The sequence between projection and indentation is interchanged on both separation surfaces of each half-shell element 50, so that when the two elements 50 are brought together they can be reliably held in position and the closed hollow cylindrical body to accommodate the threaded spindle 70 is formed. The projection-indentation combinations 55, 58 and 57, 56 respectively on the two separation surfaces of each half-shell element 50 are formed in particular in the area of the inner thread sections 51, with the result that the two half-shell elements 50 are held together reliably especially in the area of the inner thread.

Projecting radially from the outer wall of the two half-shell elements 50 is a projection 59 which runs in the circumferential direction, which, when the assembled half-shell element 50 is pushed into the housing 10, it engages in a corresponding cut-out (not shown) running in the circumferential direction in the inner wall of the housing 10 and therefore holds the half-shell elements 50 axially secure, but rotatable in the housing 10.

In this situation, it can be seen from FIG. 16 that, if the half-shell elements 50 are rotated, a tilting moment thereby exercised on the half-shell elements 50 is absorbed only in the area of this radial projection 59 running circumferentially, at the outer end of the half-shell element 50 in the housing 10. Otherwise, the delimitation area to the housing 10 can be used completely as a friction surface, which is particularly advantageous because a separation edge for a corresponding manufacturing tool no longer needs to run precisely on the friction surface since a larger area of free space 60 is available for this purpose.

The half-shell elements 50 can be made of polyoxymethylene (POM), which is a very good slide partner for polybutylene terephthalate (PBT), from which the threaded spindle 70 is manufactured preferably. PBT allows for a very high degree of precision in the adjustment of the threaded spindle 70 in the half-shell elements 50.

As can be seen from FIG. 17 and FIG. 18, the half-shell elements 50 have on the outside of their longitudinal ends in the area of the cavity 54 (see FIG. 16) cut-outs or grooves 62, which serve to secure or to press on a handwheel (not shown). As has already been explained, the two half-shell elements 50 are brought together after the insertion of the threaded spindle 70, in order thereafter for the half-shell elements 50 with the threaded spindle 70 located in them to be pressed into the housing 10 and engage there. The half-shell elements 50 are in this case held axially secure but rotatable in the housing 10, while the threaded spindle 70 is in threaded engagement by means of its outer thread 73 with the inner thread 53 of the half-shell elements 50, and, as a consequence, can be displaced in an axial direction in the half-shell elements 50 and in the housing 10. However, once the nose-type projections 78 of the threaded spindle 70 engage in the guide grooves 17 of the housing 10, the threaded spindle 70 is mounted in the housing 10 in a torsionally-resistant manner. The consequence of this is that, if the half-shell elements 50 are rotated with the aid of the handwheel referred to heretofore, the threaded spindle 70, depending on the direction of rotation and depending on the circumference of the rotation, is moved further or less far into or out of the half-shell elements 50 and the housing 10. After the threaded spindle 70 is connected to the nipple at the end of the wire of the Bowden cable arrangement, this has the consequence that, depending on the direction of rotation and the circumference of the rotation of the handwheel or the half-shell elements 50, the wire of the Bowden cable arrangement is drawn further or less far out of the sleeve 30 of the Bowden cable arrangement, supported at the housing 10, and into the housing 10.

The relative movement of the threaded spindle 70 in relation to the half-shell elements 50 is in this situation limited in both longitudinal directions by correspondingly designed stops, which are explained in greater detail hereinafter.

As can be seen from the representation of the threaded spindle in FIG. 21-FIG. 26, the threaded spindle 70 comprises, in addition to the actual spindle body with the outer thread 73 already mentioned, a thread-free spindle head 71 arranged at the upper end, as well as a thread-free spindle base 72 arranged at the lower end. The spindle base 72 is designed in the form of a broadening area surrounding the spindle body with the outer thread 73, whereby stops 83 are arranged at two diametrically opposite places of the spindle base 72. In the embodiment represented, these stops 83 are realised in the form of projections, the height of which increases gradually in the circumferential direction of the threaded spindle 70 or the spindle base 72, as FIG. 22 shows. The height of the projections or stops 83 in this situation defines in the circumferential direction (radial) stop surfaces, while the upper face of the projections or stops 83 define stop surfaces in the axial direction.

As can be seen from FIG. 20 in particular, in the inside of each half-shell element 50, at the end section of the inner thread 53, turned towards the cavity 54, a projection or stop 63 is formed, the shape of which can be complementary to the projections or stops 83 of the spindle base 72. In the embodiment shown, however, the projection or stop 63 is provided without an inclination corresponding to the inclined axial upper side of the stops 83. The projection or stop 63 further defines two stop surfaces, namely one in the plane of the corresponding separation surface of the half-shell element 50, in order, together with the corresponding stop or projection 83 of the spindle base 72, to delimit the relative movement of the threaded spindle 70 in relation to the corresponding half-shell element 50 in the circumferential direction, and a stop surface extending in the axial direction of the half-shell element 50, whereby, together with the axial upper surface of the corresponding stop or projection 83 of the spindle base 72, a delimitation of the relative movement of the threaded spindle 70 is achieved in relation to the half-shell element 50 in the axial direction also. In particular, due to the courses of the stop surfaces 63 and 83 a positive-fit and wedge-shaped stop is realised. By analogy with the projections or stops 83 of the spindle base 72, after the assembly of the two half-shell elements 50, there are likewise two counter-stops 63 provided, located essentially diametrically opposite one another.

At the upper end of the threaded spindle 70 or the half-shell elements 50 there are also corresponding stops arranged, which limit a relative movement of the threaded spindle 70 in relation to the half-shell elements 50 both in the axial direction as well as in the circumferential direction. In this situation, it can be seen from FIG. 21-FIG. 26 that the diametrically-opposed nose-shaped projections 78 already referred to project from the spindle head 71, which are to be introduced into the guide grooves 17 of the housing 10. These nose-shaped projections 78 have projections 82 on their under side, which define the stops both in the circumferential direction as well as in the axial direction. From the representations of the half-shell elements 50 of FIG. 16-FIG. 20 it can be seen that at the upper edge of each half-shell element 50, at one circumferential end, a stop 61 is formed, which is realised in particular by a gradual increase in the height of the edge of the corresponding half-shell element 50. This stop 61 interacts with the corresponding stop 82 of the threaded spindle 70. In particular, the stop 61 of the half-shell element 50 defines a stop surface in the circumferential direction for the corresponding stop surface in the circumferential direction of the projection 82 of the threaded spindle 70, while, in addition to this, the top face of the stop 61 in the axial direction creates a corresponding stop surface for the stop surface of the projection 82 or for the under side of the nose-shaped projection 78. In addition, due to the gradually increasing height of this axial stop surface of the stop 61 of the half-shell element 50, a positive-fit and wedge-shaped stop is realised in the radial direction. After the half-shell elements 50 have been assembled, two essentially diametrically opposed stops 61 are formed, corresponding to the likewise essentially diametrically opposed stops 82 of the threaded spindle 70.

From the foregoing description it can be seen that the stops and counter-stops of the half-shell elements 50 and of the threaded spindle 70 are in each case formed in thread-free sections of the half-shell elements 50 or of the threaded spindle 70.

The nose-shaped projections 78 of the spindle head 71 have several wave-shaped ribs 79 arranged adjacent to one another in the circumferential direction, whereby each of these ribs 79 has an elevation 80 extending in the axial direction. Due to this filigree arrangement of the nose-shaped projections 78 it is possible for each rib 79 to accommodate a linear load. The ribs 79 serve as bracing ribs, in order also to absorb a friction force fraction, and therefore support a positive-fit stop of the threaded spindle 78 in the interior of the housing 10 at its face end. This filigree formation of the nose-shaped projections 78 is rendered possible in particular because, due to the arrangement described heretofore of the stops of the half-shell elements 50 and the threaded spindle 70 with stop surfaces, which take effect in both the circumferential direction as well as in the axial direction, even in the event of misuse or the imposition of impermissibly high adjustment force, damage or even tearing of the nose-shaped projections 78 can be reliably avoided.

From the representations of the threaded spindle in FIG. 21-FIG. 24 it can be seen that the outer thread 73 of the threaded spindle 70 is not designed to be completely circumferential. Instead, thread-free sections 74 in the form of grooves are provided running in the longitudinal direction of the threaded spindle, which subdivide the outer thread 73 into three essentially equally large thread sections, arranged and spaced equally in the circumferential direction of the threaded spindle. These thread part sections have essentially the same length in the longitudinal direction of the threaded spindle and essentially the same width in its circumferential direction, i.e. they extend essentially over the same angle. By this division of the outer thread 73 of the threaded spindle 70 into three parts, the situation can be achieved that a manufacturing tool for the manufacture of the threaded spindle 73 can close in the area of the thread-free sections 74, whereby, in addition to this, the three-legged shoulder arrangement selected guarantees adequate stability of the threaded spindle inside the half-shell element 50.

The spindle head 72 comprises in its side wall the radial opening 75 already referred to, for the placement of the nipple of the wire of the Bowden cable arrangement, whereby the radial opening, with the slot 76 likewise formed in the side wall, is connected with the axial opening 77 formed in the face of the threaded spindle, so that, after the placing of the nipple of the wire of the Bowden cable arrangement through the radial opening 14 in the side wall of the housing 10 and the radial opening 75 in the side wall of the spindle head 71, the wire can be moved along the slot 15 and 76 into the axial openings 13 and 77 of the housing 10 and the threaded spindle 70 respectively, in order therefore to guide the wire in the axial direction out of the threaded spindle 70 and the housing 10 to the outside. The nipple of the wire in this situation is held in the interior space defined in the interior of the threaded spindle 70.

As can be seen in particular from FIG. 21, FIG. 22, and FIG. 25, in the interior of the spindle head 71 there are several ribs 84 provided, running in the longitudinal direction along the inner wall of the spindle head 71, whereby, in the embodiment shown, in particular four such ribs 84 are provided, which are distributed equally along the circumference of the inner wall of the spindle head 71. These ribs 84 serve to position the wire and the nipple located at the corresponding end of the wire respectively inside the axial opening 77, in such a way that the nipple is prevented from coming in contact with the inner wall of the spindle head 71, which otherwise would result in friction losses. In particular, the ribs 84 are designed in such a way that the nipple and the wire respectively are held essentially centrally in the axial opening 77. In this way, it can also be ensured that an adjustment of the threaded spindle 70 can be transferred as precisely as possible in the axial direction onto the wire of the Bowden cable arrangement, with the result that a tilting of the threaded spindle 70 inside the housing 10 or inside the half-shell element 50 respectively can be avoided.

On the opposite side of the radial opening 75, in the side wall of the spindle head 71, a further radial opening 81 is formed, in the form of a somewhat smaller hole, which allows for the engagement of a manufacturing tool for the manufacture of the threaded spindle. During the manufacture of the threaded spindle, the most concentric position possible of the spindle in relation to the manufacturing tool is required. The radial openings 81 and 75 make it possible that, during the sliding of a slide element of the manufacturing tool into the interior of the spindle during manufacture, the spindle can be reliably held in position. This allows for a filigree manufacture of the threaded spindle 70.

1. Adjustment device for a Bowden cable arrangement
with a housing (10),
with a first threaded part (70), which is guided in the housing (10) such as to be torsionally resistant and axially movable, and which is to be coupled to the Bowden cable arrangement, and with a second threaded part (50), which is arranged in an axially resistant and rotatable manner in the housing (10) and is in threaded engagement with the first threaded part (70),
whereby the housing (10) has a projection (16) with an opening (13)
and
whereby a sleeve (30) is provided for, which has an opening (32) for accommodating a sheath of the Bowden cable arrangement, whereby the sleeve (30) has a passage hole (36), through which a wire of the Bowden cable arrangement can be guided to couple with the first threaded part (70) by guiding the wire through the opening (13) of the projection (16) of the housing (10), and
whereby the sleeve (30) has a peripheral section (33) which, when the sleeve (30) is placed on the projection (16) of the housing (10), engages around the projection of the housing.

2. Adjustment device according to claim 1,
whereby the opening (32) provided to accommodate the sheath of the Bowden cable arrangement is formed at one longitudinal end of the sleeve (30) and the peripheral section (33) at another longitudinal end of the sleeve (30).

3. Adjustment device according to claim 1,
whereby the sleeve (30) has a stop surface for the sheath of the Bowden cable arrangement.

4. Adjustment device according to claim 3,
whereby the stop surface for the sheath of the Bowden cable arrangement has the passage hole (36) for the wire of the Bowden cable arrangement.

5. Adjustment device according to claim 3,
whereby the stop surface for the sheath of the Bowden cable arrangement runs essentially perpendicular to the longitudinal axis of the sleeve (30).

6. Adjustment device according to claim 3,
whereby the stop surface for the sheath of the Bowden cable arrangement is formed by a projection (35), which projects into the peripheral section (33) in such a way that, when the sleeve (30) is placed on the projection (16) of the housing (10), the projection (35) of the sleeve (30) projects into the opening (13) of the projection of the housing.

7. Adjustment device according to claim 6,
whereby the projection (16) of the housing (10), when the sleeve (30) is placed in position, is held in positive fit in an indentation (34) formed between the peripheral section (33) and the projection (35) of the sleeve (30).

8. Adjustment device according to claim 6,
whereby the projection (35) of the sleeve (30) has an essentially circular cross-section.

9. Adjustment device according to claim 1,
whereby the projection (16) of the housing (10) and the peripheral section (33) of the sleeve (30) have an essentially circular cross-section.

10. Adjustment device according to claim 1,
whereby the sleeve (30) is designed to be rotationally symmetrical in relation to its longitudinal axis.

11. Adjustment device according to claim 1,
whereby ribs (37) for fixing the sheath of the Bowden cable arrangement in the opening (32) of the sleeve (30) are formed in the opening (32) of the sleeve (30), which is provided so as to accommodate the sheath of the Bowden cable arrangement.

12. Adjustment device according to claim 1,
whereby in a side wall of the housing (10) a further opening (14) is formed, which is connected with the opening (13) in the projection (16) of the housing (10) via a slot (15), and
whereby the peripheral section (33) of the sleeve (30) is designed in such a way that, when the sleeve (30) is placed on the projection (16) of the housing (10), deformation of the slot (15) of the housing (10) and of the opening (13) formed in the projection (16) of the housing (10) is avoided when the adjustment device is actuated.

13. Adjustment device according to claim 1,
whereby the opening (32) provided in order to accommodate the sheath of the Bowden cable arrangement is formed in a closed circumferential edge of an accommodation section (31) of the sleeve (30).

14. Adjustment device for a Bowden cable arrangement
with a housing (10),
with a first threaded part (70), which is guided in the housing (10) such as to be torsionally resistant and axially movable, and which is to be coupled to the Bowden cable arrangement, and with a second threaded part (50), which is arranged in an axially resistant and rotatable manner in the housing (10) and is in threaded engagement with the first threaded part (70),
whereby the first threaded part (70) and the second threaded part (50) in each case have thread sections (75; 33) which are in threaded engagement with one another, and whereby the first threaded part (70) and the second threaded part (50) in each case have a stop (82, 83; 61, 63) for the other threaded part, located on the threaded section adjoining the individual threaded section (73; 53) in each case.

15. Adjustment device according to claim 14,
whereby the stops (82, 83; 61, 63) of the first and second threaded part (70; 50) delimit a movement between the first and second threaded part in both the circumferential direction as well as in the axial direction of the adjustment device.

16. Adjustment device according to claim 14,
whereby one threaded part of the first and second threaded parts is a threaded spindle (70) with an outer thread (73), and the other threaded part of the first and second threaded parts is essentially a hollow cylinder in form, with an inner thread (53), whereby the outer thread (73) of the threaded spindle (70) is in threaded engagement with the inner thread (53) of the other hollow-cylinder threaded part (50).

17. Adjustment device according to claim 16,
whereby the threaded spindle (70) has at a thread-free end section (82) at least one projection (83), which defines at least one stop surface.

18. Adjustment device according to claim 17,
whereby the at least one projection (83) at the thread-free end section (82) of the threaded spindle (70) defines both a stop surface which takes effect in the circumferential direction of the threaded spindle (70) and a stop surface which takes effect in the axial direction of the threaded spindle (70).

19. Adjustment device according to claim 17,
whereby the height of the at least one projection (83) at the thread-free end section (82) of the threaded spindle (70) increases gradually in the circumferential direction of the threaded spindle (70).

20. Adjustment device according to claim 17,
whereby the threaded spindle (70) at the thread-free end section (82) has at least two diametrically-opposed projections (83) as stops.

21. Adjustment device according to claim 16,
whereby the threaded spindle (70) has at least one nose-shaped projection (78) at one thread-free end section (71), which defines at least one stop surface.

22. Adjustment device according to claim 21,
whereby the at least one nose-shaped projection (78) of the thread-free end section (71) of the threaded spindle (70) defines a stop surface taking effect both in the circumferential direction of the threaded spindle (70) as well as in the axial direction of the threaded spindle (70).

23. Adjustment device according to claim 21,
whereby the at least one nose-shaped projection (78) is provided with at least one rib (79).

24. Adjustment device according to claim 23,
whereby the at least one rib (79) is formed on one upper side of the at least one nose-shaped projection (78) and the at least one stop surface is formed on an under side of the at least one nose-shaped projection (78).

25. Adjustment device according to claim 23,
whereby the at least one rib (79) has at least one elevation (80).

26. Adjustment device according to claim 25,
whereby the at least one elevation (80) of the at least one rib (79) is directed in the axial direction of the threaded spindle (70), so that the at least one rib (79) interacts with the at least one elevation (80) as a stop against an inner wall of the housing (10).

27. Adjustment device according to claim 23,
whereby the threaded spindle (70) has at least two diametrically-opposed nose-shaped projections (78) with in each case several wave-shaped ribs (79) arranged next to one another in the circumferential direction of the threaded spindle.

28. Adjustment device according to claim 16,
whereby the threaded part (50), essentially a hollow cylinder in form, has at least one projection (61) at one thread-free end section, with its height increasing gradually in the circumferential direction, whereby the at least one projection (61) defines a stop surface taking effect in the circumferential direction as well as a stop surface taking effect in the axial direction.

29. Adjustment device according to claim 28,
whereby the stops (82, 83; 61, 63) of the first threaded part (70) and of the second threaded part (50) are designed in such a way that positive-fit stop surfaces are defined by the stops between the first threaded part (70) and the second thread part (50).

30. Adjustment device for a Bowden cable arrangement
with a housing (10),
with a first threaded part (70), which is guided in the housing (10) such as to be torsionally resistant and axially movable, and which is to be coupled to the Bowden cable arrangement, and with a second threaded part (50), which is arranged in an axially resistant and rotatable manner in the housing (10) and is in threaded engagement with the first threaded part (70),
whereby a threaded part of the first and second threaded parts has a threaded spindle (70) with an outer thread (73), which is in threaded engagement with an inner thread (53) of the other threaded part (50), and whereby the outer thread (73) of the threaded spindle (70) has at least two threaded sections, separated in the circumferential direction of the threaded spindle (70) by thread-free sections (74).

31. Adjustment device according to claim 30,
whereby the thread-free sections (74) run in groove form in the longitudinal direction of the threaded spindle (70).

32. Adjustment device according to claim 30,
whereby the at least two threaded sections of the outer thread (73) of the threaded spindle (70) are distributed uniformly over the circumference of the threaded spindle (70).

33. Adjustment device according to claim 30,
whereby the at least two threaded sections of the outer thread (73) of the threaded spindle (70) extend in the longitudinal direction of the threaded spindle (70) essentially over the same length, and in the circumferential direction of the threaded spindle (70) extend essentially over the same angle.

34. Adjustment device according to claim 30,
whereby the outer thread (73) of the threaded spindle (70) is subdivided into three thread sections separated by the thread-free sections (74).

35. Adjustment device according to claim 30,
whereby the threaded spindle (70) is the first threaded part to be connected to the Bowden cable arrangement.

36. Adjustment device according to claim 30,
whereby the other threaded part (50) is essentially a hollow cylinder in form.

37. Adjustment device for a Bowden cable arrangement
with a housing (10),
with a first threaded part (70), which is guided in the housing (10) such as to be torsionally resistant and axially movable, and which is to be coupled to the Bowden cable arrangement, and with a second threaded part (50), which is arranged in an axially resistant and rotatable manner in the housing (10) and is in threaded engagement with the first threaded part (70),
whereby the first threaded part (70) is guided in the housing (10) in the longitudinal direction along at least one guide groove (17),
whereby the at least one guide groove (17) is delimited by projections (18) projecting from an inner wall of the housing (10), and
whereby a material cut-out (19) is provided between adjacent projections (18) in the circumferential direction of the housing (10), on one side of the projections on which the projections (18) do not delimit the at least one guide groove (17).

38. Adjustment device according to claim 37,
whereby the first threaded part (70) has at least one nose-shaped projection (78), which is guided in the at least one guide groove (17) of the housing (10) in the longitudinal direction of the housing.

39. Adjustment device according to claim 37,
whereby the projections (18) run in the longitudinal direction of the housing (10).

40. Adjustment device according to claim 37,
whereby the first threaded part (70) has at least two nose-shaped projections (78) which are guided in at least two guide grooves (17) running in the longitudinal direction of the housing (10), and
whereby in each case a material cut-out (19) is provided between two adjacent projections (18) in the circumferential direction of the housing (10) on one side of the projection on which the projections (18) do not delimit one of the guide grooves (17).

41. Adjustment device according to claim 37,
whereby the material cut-out (19) between the adjacent projections (18) is of such a nature that the adjacent projections (18) are not connected to one another over their entire length in the longitudinal direction of the housing (10).

42. Adjustment device according to claim 37,
whereby the material cut-out (19) between the adjacent projections (18) is of such a nature that the adjacent projections (18) are separated from one another over their entire length in the longitudinal direction of the housing (10).

43. Adjustment device according to claim 37,
whereby the first threaded part (70) has at least one nose-shaped projection (78) which is guided in the at least one guide groove (17) of the housing (10) and has at least one rib (79) projecting from the nose-shaped projection (78).

44. Adjustment device according to claim 43,
whereby the at least one rib (79) of the at least one nose-shaped projection (78) has at least one elevation (80) directed in the longitudinal direction of the first threaded part (70).

45. Adjustment device according to claim 43,
whereby the at least one rib is wave-shaped.

46. Adjustment device according to claim 43,
whereby the at least one nose-shaped projection (78) of the first threaded part (70) has several ribs (79) arranged next to one another in the circumferential direction of the first threaded part (70).

47. Adjustment device for a Bowden cable arrangement
with a housing (10),
with a first threaded part (70), which is guided in the housing (10) such as to be torsionally resistant and axially movable, and which is to be coupled to the Bowden cable arrangement, and with a second threaded part (50), which is arranged in an axially resistant and rotatable manner in the housing (10) and is in threaded engagement with the first threaded part (70),
whereby the first threaded part (70) has at one longitudinal end an opening (77) for a wire of the Bowden cable arrangement in such a way that the wire can be guided in the longitudinal direction of the first threaded part (70) via an opening (77) into the first threaded part (70), in order to be connected there to the first threaded part (70), and
whereby positioning means (84) are provided in the opening (77) of the first threaded part (70) for the positioning of the wire in the opening (77).

48. Adjustment device according to claim 47,
whereby positioning means comprise several projections (84) projecting from an inner wall of the first threaded part (70).

49. Adjustment device according to claim 48,
whereby the projections (84) are designed in the form of ribs.

50. Adjustment device according to claim 48,
whereby the projections (84) are arranged distributed uniformly in the circumferential direction of the first threaded part (70) along the inner wall of the first threaded part (70).

51. Adjustment device according to any one of claim 47,
whereby the positioning means comprise four projections (84) projecting from the inner wall of the first threaded part (70).

52. Adjustment device according to claim 47,
whereby a further opening (75) is provided in a side wall of the first threaded part (70), which is connected with the hole (77) formed at the longitudinal end of the first threaded part (70) by means of a slot (76) formed in the side wall.

53. Adjustment device according to claim 47,
whereby the positioning means (84) are designed in such a way that they retain the wire essentially centrally in the opening (77) formed in the longitudinal end of the first threaded part (70).

54. Adjustment device for a Bowden cable arrangement
with a housing (10),
with a first threaded part (70), which is guided in the housing (10) such as to be torsionally resistant and axially movable, and which is to be coupled to the Bowden cable arrangement, and with a second threaded part (50), which is arranged in an axially resistant and rotatable manner in the housing (10) and is in threaded engagement with the first threaded part (70),
whereby a threaded part of the first and second threaded parts is a threaded spindle (70) with an outer thread (73), which is in threaded engagement with an inner thread (53) of the other threaded part,
whereby the other threaded part is formed by several part-shell elements (50), whereby threaded sections of the inner wall (53) are formed on the inner walls of the part-shell elements (50), and
whereby the threaded sections of the inner wall (53) are formed at separation surfaces of the part-shell elements (50), and
whereby at separation surfaces of the part-shell elements (50) the threaded part sections are rounded off.

55. Adjustment device according to claim 54,
whereby at the separation surfaces of the part-shell elements (50) in each case a combination is formed of a projection (55, 57) and an indentation (56, 58), such that the projection (55, 57) at the separation surface of one of the part-shell elements (50) can engage in the indentation (56, 58) at the separation surface of another of the part-shell elements (50).

56. Adjustment device according to claim 55,
whereby each part-shell element (50) has two separation surfaces, in each case with a combination of a projection (55, 57) and an indentation (56, 58), whereby the sequence of the projection (55) and the indentation (58) of the one separation surface in the longitudinal direction of the corresponding part-shell element (50) is opposed to the sequence of the projection (57) and the indentation (56) of the other separation surface of the corresponding part-shell element (50).

57. Adjustment device according to claim 55,
whereby the at least one combination of projection (55, 57) and indentation (56, 58) in each part-shell element (50) is provided in the area of the corresponding threaded part section (53).

58. Adjustment device according to claim 54,
whereby the part-shell elements (50) are retained axially secure in the housing (10) by an engagement connection.

59. Adjustment device according to claim 58,
whereby the engagement connection of the individual part-shell elements (50) comprise projections (59) projecting outwards, which engage in an indentation formed in an inner wall of the housing (10).

60. Adjustment device according to claim 59,
whereby the projections (59) projecting outwards from the part-shell elements (50) are formed in the area of the threaded part sections (53) on the outer sides of the part-shell elements (50).

61. Adjustment device according to claim 54,
whereby the threaded spindle (70) is the first threaded part, while the part-shell elements (50) form the second threaded part.

62. Adjustment device for a Bowden cable arrangement
with a housing (10),
with a first threaded part (70), which is guided in the housing (10) such as to be torsionally resistant and axially movable, and which is to be coupled to the Bowden cable arrangement, and with a second threaded part (50), which is arranged in an axially resistant and rotatable manner in the housing (10) and is in threaded engagement with the first threaded part (70),
whereby a threaded part of the first and second threaded parts is a threaded spindle (70) with an outer thread (73), which is in threaded engagement with an inner thread (53) of the other threaded part, and
whereby at least one opening (81) is formed in the threaded spindle (70) for holding the threaded spindle (70) in position during the manufacture of the spindle (70).

63. Adjustment device according to claim 62,
whereby the at least one opening (81) is formed in a side wall of the threaded spindle (70) in a thread-free section (71) of the threaded spindle (70).

64. Adjustment device according to claim 63,
whereby the thread-free section is a head section (71) of the threaded spindle (70).

65. Adjustment device according to claim 62,
whereby the at least one opening (81) for holding the threaded spindle (70) in position during the manufacture of the threaded spindle (70) is located opposite a further opening (75) in the threaded spindle (70) to introduce the wire of the Bowden cable arrangement.

66. Adjustment device according to claim 1,
whereby the first threaded part (70) is a threaded spindle with an outer thread (73) and the second threaded part (50) is a hollow cylinder in form, with an inner thread (53) which is in threaded engagement with the outer thread (73) of the threaded spindle.

67. Adjustment device according to claim 66,
whereby the second threaded part (50), in the form of a hollow cylinder, is formed by two half-shell elements, whereby threaded part sections (53) of the inner thread of the second threaded part are formed on inner walls of the half-shell elements.

68. Adjustment device according to claim 67,
whereby the two half-shell elements (50) are held in an axially secure manner in the housing (10) by projections (59) which project from outer sides of the half-shell elements (50).

69. Adjustment device according to claim 1,
whereby the housing (10) and the first threaded part (70) in each case have an opening (14; 75) formed in a corresponding side wall and an axial opening (13; 77) formed on a corresponding longitudinal end, which are connected via a slot (15; 76) formed in the corresponding side wall with the opening (14; 75) formed in the corresponding side wall.

70. Adjustment device according to claim 1,
whereby the second threaded part (50) can be connected to an actuating element for rotating the second threaded part (50) in the housing (10).

71. Adjustment device according to claim 1,
whereby the housing (10) is made of a polyamide plastic.

72. Adjustment device according to claim 1,
whereby the first threaded part (70) is made of a polybutylene terephthalate plastic.

73. Adjustment device according claim 1,
whereby the second threaded part (50) is made of a polyoxymethylene plastic.
